(19) United States
(12) Patent Application Publication
(10) Pub. No.: US 2026/0035309 A1
(43) Pub. Date: Feb. 5, 2026

(54) SOLUBLE CERAMIC SHELL/CORE AND PREPARATION METHOD AND APPLICATION

(71) Applicant: Huazhong University of Science and Technology, Wuhan (CN)

(72) Inventors: Wenming Jiang, Wuhan (CN); Ziwei Peng, Wuhan (CN); Xiaopeng Yu, Wuhan (CN); Qingqing Li, Wuhan (CN); Linghui Yu, Wuhan (CN); Taoxiong Guo, Wuhan (CN); Li Yang, Wuhan (CN); Zitian Fan, Wuhan (CN)

(21) Appl. No.: 19/356,032

(22) Filed: Oct. 10, 2025

(30) Foreign Application Priority Data
Jan. 7, 2025 (CN) 2025100223192

(51) Int. Cl. C04B 35/626; B33Y 10/00; B33Y 80/00; C04B 35/057; C04B 35/632; C04B 35/64

(52) U.S. Cl. CPC C04B 35/6261; B33Y 10/00; B33Y 80/00; C04B 35/057; C04B 35/62655; C04B 35/6269; C04B 35/632; C04B 35/64; C04B 2235/6026; C04B 2235/6567

(57) ABSTRACT

The present disclosure proposes a soluble ceramic shell/core and a preparation method and an application, and belongs to the technical field related to rapid casting. The preparation method includes the following steps: step S1: performing ball milling and drying on a raw material containing calcium oxide and a modifying solution to obtain a modified calcium oxide powder; step S2: printing the modified calcium oxide powder into a ceramic shell/core primary blank, and performing heat curing, infiltration and drying to obtain a ceramic shell/core blank; and step S3: sintering the ceramic shell/core blank to obtain the soluble ceramic shell/core. The present disclosure prepares the ceramic shell/core by a 3DP molding process, which is simple in procedure and short in production cycle, and does not need support, wherein solubility of the calcium oxide, after casting, makes it easier for a casting to be de-shelled. In addition, the raw material during a sintering process cannot be decomposed, which reduces shrinkage during the sintering process and can meet requirements for molding a large and complex structural ceramic shell/core.

### TECHNICAL FIELD

The present disclosure relates to the technical field related to rapid casting, in particular to a soluble ceramic shell/core and a preparation method and an application.

### BACKGROUND

A binder jetting (BJ) technology is a method of additive manufacturing, also known as three dimensional printing (3DP) molding technology, which is based on a powder bed process, jets an adhesive on a powder bed layer by layer through an ink nozzle selection area, forms a part green body through superposition layer by layer, and through subsequent curing, infiltration, degreasing, and sintering processes, densifies the part green body, and obtains a part with good mechanical properties. Compared with other additive manufacturing technologies, the 3DP technology does not need laser or auxiliary heating molding, has advantages of wide range of materials, high efficiency, low cost, no support, green and environmental protection, etc., with a wide range of application fields, and has greater potential for preparation of ceramic shells/cores to achieve rapid casting.

Traditional materials applicable to the ceramic shells/cores for titanium alloy casting mainly include ZrO₂, Y₂O₃, CaO, etc. An advantage of these materials is mainly to avoid an interfacial reaction with a titanium alloy during casting, which leads to an influence on accuracy and properties of castings. However, the ZrO₂ and Y₂O₃ are expensive, greatly increasing a production cost, and after casting, removal of ceramic-type shells/cores is difficult. A CaO shell/core may hydrolyze for de-shelling, but due to a characteristic of the CaO material being prone to water absorption and agglomeration in the air, it is difficult to realize 3DP of the powder bed. Therefore, there is an urgent need to develop a preparation method applicable to a soluble ceramic shell/core, to solve the problems existing in the above preparation technology and ceramic shell/core materials, and to meet industrial production requirements.

### SUMMARY

In view of the above deficiencies of the prior art or the requirements for improvement, the present disclosure provides a soluble ceramic shell/core based on microdroplet jet bonding molding and a preparation method and application thereof. A ceramic shell/core material uses CaO and is directly dissolved in water, thus the ceramic shell/core collapses, and separates from a casting easily, which greatly simplifies a later de-shelling process, and a dissolution product Ca(OH)₂ has small solubility, most of which forms a precipitate, which is convenient for later recycling and treatment. The present disclosure, due to a modification of CaO, optimizes a printing problem caused by a powder agglomeration during a process of microdroplet jet bonding molding. In addition, CaO is not decomposed during a sintering process, and a shrinkage deformation of the ceramic shell/core after sintering is small, which can meet the industrial production requirements.

A technical solution of the present disclosure is realized as follows. The present disclosure provides a preparation method of a soluble ceramic shell/core, including the following steps:
step S1: performing ball milling and drying on a raw material containing calcium oxide and a modifying solution, and performing sieving to obtain a modified calcium oxide powder;
step S2: printing the modified calcium oxide powder into a ceramic shell/core primary blank, and performing heat curing, infiltration and drying to obtain a ceramic shell/core blank; and
step S3: sintering the ceramic shell/core blank to obtain the soluble ceramic shell/core.

Based on the above technical solution, preferably, in the step S1, the modifying solution includes a modifier and a modifying solvent.

Based on the above technical solution, preferably, the modifier is selected from at least one of ethyl bromide, bromobenzene, a silane coupling agent, stearic acid, or n-octadecyltrichlorosilane.

Based on the above technical solution, preferably, the modifying solvent is selected from at least one of methanol, ethanol, glycerol, or acetone.

Based on the above technical solution, preferably, by mass, the amount of the modifier is 1-10 parts, and the amount of the modifying solvent is 90-99 parts.

Based on the above technical solution, preferably, by mass, the amount of the modifier is independently selected from any value of 1 part, 2 parts, 3 parts, 4 parts, 5 parts, 6 parts, 8 parts, and 10 parts, or a range value between any two of the above.

Based on the above technical solution, preferably, by mass, the amount of the modifying solvent is independently selected from any value of 99 parts, 98 parts, 97 parts, 96 parts, 95 parts, 94 parts, 92 parts, and 90 parts, or a range value between any two of the above.

Based on the above technical solution, preferably, in the step S1, by mass, the amount of the calcium oxide is 30-70 parts, and the amount of the modifying solution is 70-30 parts.

Based on the above technical solution, preferably, in the step S1, by mass, the amount of the calcium oxide is independently selected from any value of 30 parts, 40 parts, 50 parts, 60 parts, and 70 parts, or a range value between any two of the above.

Based on the above technical solution, preferably, in the step S1, by mass, the amount of the modifying solution is independently selected from any value of 70 parts, 60 parts, 50 parts, 40 parts, and 30 parts, or a range value between any two of the above.

Based on the above technical solution, preferably, in the step S1, time of the ball milling is 6 h-12 h.

Based on the above technical solution, preferably, in the ball milling, a diameter of a milling ball is 0.8 mm-2 mm.

Based on the above technical solution, preferably, in the ball milling, a mass fraction of the milling ball is 5%-15% that of the raw material.

Based on the above technical solution, preferably, a temperature of the drying is 50° C.-100° C., and time of the drying is 6 h-24 h.

Based on the above technical solution, preferably, in the sieving after the drying, a mesh count of a sieve is 100 mesh-500 mesh.

Based on the above technical solution, preferably, in the step S2, a temperature of the heat curing is 150° C.-180° C., and time of the heat curing is 2 h-5 h.

Based on the above technical solution, preferably, a temperature of the drying is 50° C.-90° C., and time of the drying is 8 h-24 h.

Based on the above technical solution, preferably, time of the infiltration is 30 s-3 min.

Based on the above technical solution, preferably, in the step S2, an infiltration liquid used in the infiltration is selected from at least one of a nano-SiO₂ ethanol dispersion, a nano-ZrO₂ ethanol dispersion, or a nano-YiO₂ ethanol dispersion.

Based on the above technical solution, preferably, in the step S2, a layer height of the printing is 0.05 mm-0.20 mm.

Based on the above technical solution, preferably, an adhesive for the printing is phenolic resin, and saturation of the adhesive is 70%-140%.

Based on the above technical solution, preferably, in the step S3, the sintering includes first sintering and second sintering.

Based on the above technical solution, preferably, a temperature of the first sintering is 600° C.-800° C., and time of the first sintering is 1 h-3 h.

Based on the above technical solution, preferably, a temperature of the second sintering is 1300° C.-1500° C., and time of the second sintering is 2 h-3 h.

Based on the above technical solution, preferably, a heating rate of the sintering is 1° C./min−5° C./min.

According to another aspect of the present application, a soluble ceramic shell/core prepared and obtained by the preparation method described above is provided.

According to yet another aspect of the present application, an application of the soluble ceramic shell/core described above in a cast structural member. A material of the cast structural member is selected from at least one of cast iron, cast steel, an aluminum alloy, a titanium alloy, or a magnesium alloy.

Based on the above technical solution, preferably, after casting is completed, the structural member with the ceramic shell/core is put into water, and the ceramic shell/core reacts with the water, cracks and collapses, and separates from the structural member, thus completing a de-shelling procedure.

As an optional implementation, the present disclosure is implemented by the following technical solution.

The preparation method of the soluble ceramic shell/core of the present disclosure includes the following steps:
(1) first mixing, by mass, 1-10 parts of modifier and 99-90 parts of modifying solvent, performing heating in water bath at 40° C.-80° C. for 1 h-4 h, and obtaining the modifying solution after uniform mixing; and adding 30-70 parts of calcium oxide, 70-30 parts of modifying solution and ball milling beads to a ball milling tank, performing ball milling using a planetary ball mill, then drying a ball-milled uniform slurry, and performing sieving through a sieve to obtain the modified calcium oxide powder;
(2) using the modified calcium oxide powder as a raw material, using a microdroplet jet bonding molding process to prepare the ceramic shell/core primary blank, then performing heat curing, using the infiltration liquid to perform infiltration, performing complete drying, and obtaining the ceramic shell/core blank; and
(3) designing a sintering temperature curve, and sintering the ceramic shell/core blank obtained in the step (2), i.e., obtaining the soluble ceramic shell/core.

Based on the above technical solution, preferably, the modifier may be decomposed before a first stage of sintering.

Based on the above technical solution, preferably, an adhesive used in the microdroplet jet bonding molding process is phenolic resin; and printing parameters are as follows: the layer height of the printing is 0.05 mm-0.20 mm, and saturation of the adhesive is 70%-140%.

In the present disclosure, solute molecules in the infiltration liquid used for the infiltration are not decomposed at above 1500° C. A solute component of the infiltration liquid does not react with the structural member during the casting process. The infiltration liquid is used to infiltrate into pores between the calcium oxide powder, thus keeping a shape of the ceramic shell/core intact, avoiding collapse of the blank during the sintering process, and enhancing strength of the sintered blank. In the present disclosure, the infiltration liquid is used to infiltrate into the pores between the calcium oxide powder, thus keeping the shape of the ceramic shell/core intact, and avoiding the collapse of the blank during the sintering process. The solute molecules in the infiltration liquid can react with the calcium oxide, thus enhancing strength of a sintered sample. The solute component of the infiltration liquid does not react with the structural member during the casting process. After casting is completed, the structural member with the ceramic shell/core is put into water, and the calcium oxide in the ceramic shell/core reacts with the water, making the ceramic shell/core crack and collapse, and separate from the structural member, thus completing de-shelling.

In the present disclosure, the modifying solution is used to modify the calcium oxide, the solution is uniformly mixed and dried by ball milling, and after the solvent volatilizes completely, a surface of the CaO powder is fully coated with the modifier, thus reducing contact between the CaO and the air, and reducing an influence of denaturation and agglomeration during the printing process on a final printing quality.

Compared with the prior art, the soluble ceramic shell/core of the present disclosure has the following beneficial effects.

(1) The present disclosure uses the microdroplet jet bonding molding process to prepare the ceramic shells/core, which may solve the limitations of the traditional process in molding a large and complex structural ceramic shell/core, shorten a production cycle, reduce a production cost, and meet production requirements of a social market. Meanwhile, compared with other additive manufacturing technologies, the microdroplet jet bonding molding process does not need laser or auxiliary heating molding, and has advantages of wide range of materials, high efficiency, low cost, no support for the molding process, green and environmental protection, etc., with a wide range of application fields.

(2) The ceramic shell/core prepared using the modified CaO in the present disclosure is low in raw material price. In addition, because the CaO can react with water, the casting with the ceramic shell/core may be put into hot water and fully immersed, and the ceramic shell/core hydrolyzes and collapses in the water, so as to realize the automatic separation of the ceramic shell/core from the casting, which greatly simplifies the later de-shelling procedure. A process of dissolution of the CaO ceramic shell/core is:

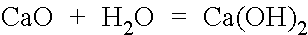

The solubility of the reaction product Ca(OH)₂ is small, and decreases with the increase of the temperature, so most of the Ca(OH)₂ forms the precipitate, which is convenient for the later recycling and treatment, green, and environmentally friendly, and has a broad application prospect.

(3) The present disclosure uses the method of ball milling and modifier modification to modify the CaO powder, and prepares the CaO modified powder with good water resistance, which solves problems of difficulty in laying powder for 3DP molding of traditional CaO powder, and powder denaturation in the printing process. The present disclosure provides a feasible manufacturing method for 3DP manufacturing of the CaO soluble ceramic core, which opens up a new direction for low-cost manufacturing of the soluble ceramic core.

### BRIEF DESCRIPTION OF DRAWINGS

To describe the technical solutions in the embodiments of the present invention or in the related art more clearly, the following briefly introduces the accompanying drawings for describing the embodiments or the related art. Apparently, the accompanying drawings in the following description show merely some embodiments of the present invention, and a person of ordinary skill in the art may still derive other drawings from the accompanying drawings without creative efforts.

FIG. 1 is a flow process diagram of preparing a soluble ceramic shell/core of the present disclosure.

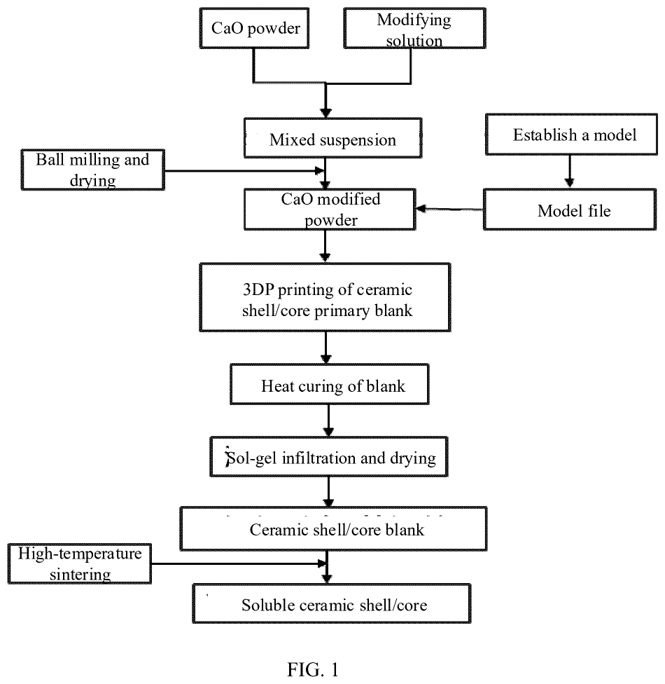

### DETAILED DESCRIPTION

The technical solutions in the embodiments of the present invention will be clearly and completely described below with reference to the embodiments of the present invention, and it is obvious that the described embodiments are only a part of the embodiments of the present invention but not all of them. All other embodiments obtained by a person of ordinary skill in the art based on the embodiments of present disclosure without making creative efforts shall fall within the protection scope of present disclosure.

### Embodiment 1

A preparation method of a soluble ceramic shell/core provided in Embodiment 1 of the present disclosure mainly includes the following steps.

(1) 5 g stearic acid and 95 g anhydrous ethanol were mixed and heated in water bath at 60° C. for 2 h, and a modified solution was obtained after uniform mixing. 65 g calcium oxide and 35 g modified solution were added to a ball milling tank, and then zirconia ball milling beads with a diameter of 1 mm and a mass fraction of 8% that of a raw material were added. Ball milling was performed using a planetary ball mill for 12 h, and then a ball-milled uniform slurry was dried at 50° C. for 24 h, crushed and sieved through a 200-mesh sieve to obtain a coarse modified calcium oxide powder.

A designed ceramic shell/core stl three-dimensional structure was imported into a computer printing program, and printing parameters were adjusted (a layer height of printing was 0.15 mm, and saturation of an adhesive was 80%). Then sieved modified calcium oxide powder was laid all over a powder feeding cylinder, a ceramic pad and a stainless steel bottom plate were placed on a surface of a working cylinder, and a uniform calcium oxide powder was laid flat. After printing started, a nozzle started to jet a phenolic resin adhesive in accordance with a path sliced by a computer. After the nozzle completed one ink jet, the powder feeding cylinder and the working cylinder rose and fell by one layer height respectively. A powder laying process was completed by self-rotation and movement of a powder laying roller. A cycle repeated itself, so as to complete a whole printing process of the ceramic shell/core.

(2) After printing ended, the powder and a ceramic shell/core primary blank together with the stainless steel bottom plate were placed in a drying box for heat curing at 160° C., the drying box was closed after curing for 4 h, and the stainless steel plate was taken out after furnace cooling. Next, a blank was taken out of a powder bed, and a residual powder on the ceramic shell/core blank was removed with a brush. Subsequently, the ceramic shell/core blank was placed in a basin, into which a nano-ZrO₂ ethanol dispersion with a mass fraction of 20% was poured, timing started after all parts of the blank were completely infiltrated, and an infiltrated ceramic shell/core blank was taken out and placed in a tray after 3 min, put into the drying box at 60° C., and then taken out after drying for 12 h.

(3) Sintering of the ceramic shell/core blank used a buried burning mode, a 0.2 mm plate-shaped corundum powder was uniformly laid on a sintering special ceramic plate, then the dried ceramic shell/core blank was placed on the ceramic plate, and all parts of the blank were completely buried with the plate-shaped corundum powder. Subsequently, the blank was put into a high-temperature sintering furnace for sintering in accordance with process parameters of 600° C. sintering for 2 h, 1400° C. sintering for 2 h, and a heating rate of 2° C./min, and finally, the soluble ceramic shell/core was obtained by furnace cooling.

### Embodiment 2

A preparation method of a soluble ceramic shell/core provided in Embodiment 2 of the present disclosure mainly includes the following steps.

(1) 7 g silane coupling agent and 93 g acetone were mixed and heated in water bath at 80° C. for 2 h, and a modified solution was obtained after uniform mixing. 60 g calcium oxide and 40 g modified solution were added to a ball milling tank, and then zirconia ball milling beads with a diameter of 1.5 mm and a mass fraction of 10% that of a raw material were added. Ball milling was performed using a planetary ball mill for 10 h, and then a ball-milled uniform slurry was dried at 55° C. for 24 h, crushed and sieved through a 250-mesh sieve to obtain a coarse modified calcium oxide powder.

A designed ceramic shell/core stl three-dimensional structure was imported into a computer printing program, and printing parameters were adjusted (a layer height of printing was 0.10 mm, and saturation of an adhesive was 120%). Then sieved modified calcium oxide powder was laid all over a powder feeding cylinder, a ceramic pad and a stainless steel bottom plate were placed on a surface of a working cylinder, and a uniform calcium oxide powder was laid flat. After printing started, a nozzle started to jet a phenolic resin adhesive in accordance with a path sliced by a computer. After the nozzle completed one ink jet, the powder feeding cylinder and the working cylinder rose and fell by one layer height respectively. A powder laying process was completed by self-rotation and movement of a powder laying roller. A cycle repeated itself, so as to complete a whole printing process of the ceramic shell/core.

(2) After printing ended, the powder and a ceramic shell/core primary blank together with the stainless steel bottom plate were placed in a drying box for heat curing at 180° C., the drying box was closed after curing for 4 h, and the stainless steel plate was taken out after furnace cooling. Next, a blank was taken out of a powder bed, and a residual powder on the ceramic shell/core blank was removed with a brush. Subsequently, the ceramic shell/core blank was placed in a basin, into which a nano-YiO₂ ethanol dispersion with a mass fraction of 20% was poured, timing started after all parts of the blank were completely infiltrated, and an infiltrated ceramic shell/core blank was taken out and placed in a tray after 2.5 min, put into the drying box at 80° C., and then taken out after drying for 12 h.

(3) Sintering of the ceramic shell/core blank used a buried burning mode, a 0.2 mm plate-shaped corundum powder was uniformly laid on a sintering special ceramic plate, then the dried ceramic shell/core blank was placed on the ceramic plate, and all parts of the blank were completely buried with the plate-shaped corundum powder. Subsequently, the blank was put into a high-temperature sintering furnace for sintering in accordance with process parameters of 600° C. sintering for 2 h, 1500° C. sintering for 2 h, and a heating rate of 2° C./min, and finally, the soluble ceramic shell/core was obtained by furnace cooling.

### Embodiment 3

A preparation method of a soluble ceramic shell/core provided in Embodiment 3 of the present disclosure mainly includes the following steps.

(1) 3 g bromoethane and 97 g acetone were mixed and heated in water bath at 60° C. for 2 h, and a modified solution was obtained after uniform mixing. 70 g calcium oxide and 30 g modified solution were added to a ball milling tank, and then zirconia ball milling beads with a diameter of 0.8 mm and a mass fraction of 8% that of a raw material were added. Ball milling was performed using a planetary ball mill for 12 h, and then a ball-milled uniform slurry was dried at 60° C. for 24 h, crushed and sieved through a 320-mesh sieve to obtain a coarse modified calcium oxide powder.

A designed ceramic shell/core stl three-dimensional structure was imported into a computer printing program, and printing parameters were adjusted (a layer height of printing was 0.12 mm, and saturation of an adhesive was 100%). Then sieved modified calcium oxide powder was laid all over a powder feeding cylinder, a ceramic pad and a stainless steel bottom plate were placed on a surface of a working cylinder, and a uniform calcium oxide powder was laid flat. After printing started, a nozzle started to jet a phenolic resin adhesive in accordance with a path sliced by a computer. After the nozzle completed one ink jet, the powder feeding cylinder and the working cylinder rose and fell by one layer height respectively. A powder laying process was completed by self-rotation and movement of a powder laying roller. A cycle repeated itself, so as to complete a whole printing process of the ceramic shell/core.

(2) After printing ended, the powder and a ceramic shell/core primary blank together with the stainless steel bottom plate were placed in a drying box for heat curing at 165° C., the drying box was closed after curing for 3.5 h, and the stainless steel plate was taken out after furnace cooling. Next, a blank was taken out of a powder bed, and a residual powder on the ceramic shell/core blank was removed with a brush. Subsequently, the ceramic shell/core blank was placed in a basin, into which a nano-ZrO₂ ethanol dispersion with a mass fraction of 15% was poured, timing started after all parts of the blank were completely infiltrated, and an infiltrated ceramic shell/core blank was taken out and placed in a tray after 4 min, put into the drying box at 50° C., and then taken out after drying for 18 h.

(3) Sintering of the ceramic shell/core blank used a buried burning mode, a 0.2 mm plate-shaped corundum powder was uniformly laid on a sintering special ceramic plate, then the dried ceramic shell/core blank was placed on the ceramic plate, and all parts of the blank were completely buried with the plate-shaped corundum powder. Subsequently, the blank was put into a high-temperature sintering furnace for sintering in accordance with process parameters of 700° C. sintering for 2 h, 1450° C. sintering for 2 h, and a heating rate of 2.5° C./min, and finally, the soluble ceramic shell/core was obtained by furnace cooling.

### Embodiment 4

A preparation method of a soluble ceramic shell/core provided in Embodiment 4 of the present disclosure mainly includes the following steps.

(1) 2 g stearic acid and 98 g anhydrous ethanol were mixed and heated in water bath at 60° C. for 2 h, and a modified solution was obtained after uniform mixing. 30 g calcium oxide and 70 g modified solution were added to a ball milling tank, and then zirconia ball milling beads with a diameter of 0.8 mm and a mass fraction of 5% that of a raw material were added, ball milling was performed using a planetary ball mill for 6 h, and then a ball-milled uniform slurry was dried at 70° C. for 24 h, crushed and sieved through a 100-mesh sieve to obtain a coarse modified calcium oxide powder.

A designed ceramic shell/core stl three-dimensional structure was imported into a computer printing program, and printing parameters were adjusted (a layer height of printing was 0.05 mm, and saturation of an adhesive was 140%). Then sieved modified calcium oxide powder was laid all over a powder feeding cylinder, a ceramic pad and a stainless steel bottom plate were placed on a surface of a working cylinder, and a uniform calcium oxide powder was laid flat. After printing started, a nozzle started to jet a phenolic resin adhesive in accordance with a path sliced by a computer. After the nozzle completed one ink jet, the powder feeding cylinder and the working cylinder rose and fell by one layer height respectively. A powder laying process was completed by self-rotation and movement of a powder laying roller. A cycle repeated itself, so as to complete a whole printing process of the ceramic shell/core.

(2) After printing ended, the powder and a ceramic shell/core primary blank together with the stainless steel bottom plate were placed in a drying box for heat curing at 150° C., the drying box was closed after curing for 5 h, and the stainless steel plate was taken out after furnace cooling. Next, a blank was taken out of a powder bed, and a residual powder on the ceramic shell/core blank was removed with a brush. Subsequently, the ceramic shell/core blank was placed in a basin, into which a nano-ZrO₂ ethanol dispersion with a mass fraction of 20% was poured, timing started after all parts of the blank were completely infiltrated, and an infiltrated ceramic shell/core blank was taken out and placed in a tray after 3 min, put into the drying box at 50° C., and then taken out after drying for 24 h.

(3) Sintering of the ceramic shell/core blank used a buried burning mode, a 0.2 mm plate-shaped corundum powder was uniformly laid on a sintering special ceramic plate, then the dried ceramic shell/core blank was placed on the ceramic plate, and all parts of the blank were completely buried with the plate-shaped corundum powder. Subsequently, the blank was put into a high-temperature sintering furnace for sintering in accordance with process parameters of 600° C. sintering for 3 h, 1300° C. sintering for 3 h, and a heating rate of 1° C./min, and finally, the soluble ceramic shell/core was obtained by furnace cooling.

### Embodiment 5

A preparation method of a soluble ceramic shell/core provided in Embodiment 5 of the present disclosure mainly includes the following steps.

(1) 8 g stearic acid and 92 g anhydrous ethanol were mixed and heated in water bath at 60° C. for 2 h, and a modified solution was obtained after uniform mixing. 40 g calcium oxide and 60 g modified solution were added to a ball milling tank, and then zirconia ball milling beads with a diameter of 2 mm and a mass fraction of 15% that of a raw material were added, ball milling was performed using a planetary ball mill for 12 h, and then a ball-milled uniform slurry was dried at 100° C. for 6 h, crushed and sieved through a 500-mesh sieve to obtain a coarse modified calcium oxide powder.

A designed ceramic shell/core stl three-dimensional structure was imported into a computer printing program, and printing parameters were adjusted (a layer height of printing was 0.20 mm, and saturation of an adhesive was 70%). Then sieved modified calcium oxide powder was laid all over a powder feeding cylinder, a ceramic pad and a stainless steel bottom plate were placed on a surface of a working cylinder, and a uniform calcium oxide powder was laid flat. After printing started, a nozzle started to jet a phenolic resin adhesive in accordance with a path sliced by a computer. After the nozzle completed one ink jet, the powder feeding cylinder and the working cylinder rose and fell by one layer height respectively. A powder laying process was completed by self-rotation and movement of a powder laying roller. A cycle repeated itself, so as to complete a whole printing process of the ceramic shell/core.

(2) After printing ended, the powder and a ceramic shell/core primary blank together with the stainless steel bottom plate were placed in a drying box for heat curing at 180° C., the drying box was closed after curing for 2 h, and the stainless steel plate was taken out after furnace cooling. Next, a blank was taken out of a powder bed, and a residual powder on the ceramic shell/core blank was removed with a brush. Subsequently, the ceramic shell/core blank was placed in a basin, into which a nano-ZrO₂ ethanol dispersion with a mass fraction of 20% was poured, timing started after all parts of the blank were completely infiltrated, and an infiltrated ceramic shell/core blank was taken out and placed in a tray after 30 s, put into the drying box at 90° C., and then taken out after drying for 8 h.

(3) Sintering of the ceramic shell/core blank used a buried burning mode, a 0.2 mm plate-shaped corundum powder was uniformly laid on a sintering special ceramic plate, then the dried ceramic shell/core blank was placed on the ceramic plate, and all parts of the blank were completely buried with the plate-shaped corundum powder. Subsequently, the blank was put into a high-temperature sintering furnace for sintering in accordance with process parameters of 800° C. sintering for 1 h, 1500° C. sintering for 2 h, and a heating rate of 5° C./min, and finally, the soluble ceramic shell/core was obtained by furnace cooling.

### Embodiment 6

A preparation method of a soluble ceramic shell/core provided in Embodiment 6 of the present disclosure mainly includes the following steps.

(1) 1 g stearic acid and 99 g anhydrous ethanol were mixed and heated in water bath at 60° C. for 2 h, and a modified solution was obtained after uniform mixing. 65 g calcium oxide and 35 g modified solution were added to a ball milling tank, and then zirconia ball milling beads with a diameter of 1 mm and a mass fraction of 8% that of a raw material were added, ball milling was performed using a planetary ball mill for 12 h, and then a ball-milled uniform slurry was dried at 50° C. for 24 h, crushed and sieved through a 200-mesh sieve to obtain a coarse modified calcium oxide powder.

A designed ceramic shell/core stl three-dimensional structure was imported into a computer printing program, and printing parameters were adjusted (a layer height of printing was 0.15 mm, and saturation of an adhesive was 80%). Then sieved modified calcium oxide powder was laid all over a powder feeding cylinder, a ceramic pad and a stainless steel bottom plate were placed on a surface of a working cylinder, and a uniform calcium oxide powder was laid flat. After printing started, a nozzle started to jet a phenolic resin adhesive in accordance with a path sliced by a computer. After the nozzle completed one ink jet, the powder feeding cylinder and the working cylinder rose and fell by one layer height respectively. A powder laying process was completed by self-rotation and movement of a powder laying roller. A cycle repeated itself, so as to complete a whole printing process of the ceramic shell/core.

(2) After printing ended, the powder and a ceramic shell/core primary blank together with the stainless steel bottom plate were placed in a drying box for heat curing at 160° C., the drying box was closed after curing for 4 h, and the stainless steel plate was taken out after furnace cooling. Next, a blank was taken out of a powder bed, and a residual powder on the ceramic shell/core blank was removed with a brush. Subsequently, the ceramic shell/core blank was placed in a basin, into which a nano-ZrO₂ ethanol dispersion with a mass fraction of 20% was poured, timing started after all parts of the blank were completely infiltrated, and an infiltrated ceramic shell/core blank was taken out and placed in a tray after 3 min, put into the drying box at 60° C., and then taken out after drying for 12 h.

(3) Sintering of the ceramic shell/core blank used a buried burning mode, a 0.2 mm plate-shaped corundum powder was uniformly laid on a sintering special ceramic plate, then the dried ceramic shell/core blank was placed on the ceramic plate, and all parts of the blank were completely buried with the plate-shaped corundum powder, subsequently, the blank was put into a high-temperature sintering furnace for sintering in accordance with process parameters of 600° C. sintering for 2 h, 1400° C. sintering for 2 h, and a heating rate of 2° C./min, and finally, the soluble ceramic shell/core was obtained by furnace cooling.

### Embodiment 7

A preparation method of a soluble ceramic shell/core provided in Embodiment 1 of the present disclosure mainly includes the following steps.

(1) 10 g stearic acid and 90 g anhydrous ethanol were mixed and heated in water bath at 60° C. for 2 h, and a modified solution was obtained after uniform mixing. 65 g calcium oxide and 35 g modified solution were added to a ball milling tank, and then zirconia ball milling beads with a diameter of 1 mm and a mass fraction of 8% that of a raw material were added, ball milling was performed using a planetary ball mill for 12 h, and then a ball-milled uniform slurry was dried at 50° C. for 24 h, crushed and sieved through a 200-mesh sieve to obtain a coarse modified calcium oxide powder.

A designed ceramic shell/core stl three-dimensional structure was imported into a computer printing program, and printing parameters were adjusted (a layer height of printing was 0.15 mm, and saturation of an adhesive was 80%). Then sieved modified calcium oxide powder was laid all over a powder feeding cylinder, a ceramic pad and a stainless steel bottom plate were placed on a surface of a working cylinder, and a uniform calcium oxide powder was laid flat. After printing started, a nozzle started to jet a phenolic resin adhesive in accordance with a path sliced by a computer. After the nozzle completed one ink jet, the powder feeding cylinder and the working cylinder rose and fell by one layer height respectively. A powder laying process was completed by self-rotation and movement of a powder laying roller. A cycle repeated itself, so as to complete a whole printing process of the ceramic shell/core.

(2) After printing ended, the powder and a ceramic shell/core primary blank together with the stainless steel bottom plate were placed in a drying box for heat curing at 160° C., the drying box was closed after curing for 4 h, and the stainless steel plate was taken out after furnace cooling. Next, a blank was taken out of a powder bed, and a residual powder on the ceramic shell/core blank was removed with a brush. Subsequently, the ceramic shell/core blank was placed in a basin, into which a nano-ZrO₂ ethanol dispersion with a mass fraction of 20% was poured, timing started after all parts of the blank were completely infiltrated, and an infiltrated ceramic shell/core blank was taken out and placed in a tray after 3 min, put into the drying box at 60° C., and then taken out after drying for 12 h.

(3) Sintering of the ceramic shell/core blank used a buried burning mode, a 0.2 mm plate-shaped corundum powder was uniformly laid on a sintering special ceramic plate, then the dried ceramic shell/core blank was placed on the ceramic plate, and all parts of the blank were completely buried with the plate-shaped corundum powder, subsequently, the blank was put into a high-temperature sintering furnace for sintering in accordance with process parameters of 600° C. sintering for 2 h, 1400° C. sintering for 2 h, and a heating rate of 2° C./min, and finally, the soluble ceramic shell/core was obtained by furnace cooling.

### Comparative Example 1

The step (1) in Embodiment 1 was replaced with that 65 g calcium oxide and anhydrous ethanol were ball-milled directly using a planetary ball mill for 12 h, and sieved through a 200-mesh sieve to obtain a calcium oxide powder, and printing was performed using a printing method in Embodiment 1. Remaining preparation steps were kept the same as those in Embodiment 1. Since the calcium oxide was not modified with a modifying solution, printing agglomeration occurred when the calcium oxide was used for direct printing, and a ceramic shell/core primary blank could not be effectively printed.

### Comparative Example 2

“5 g stearic acid and 95 g anhydrous ethanol were mixed” in the step (1) of Embodiment 1 was replaced with that “0.8 g stearic acid and 99.2 g anhydrous ethanol were mixed”. Remaining preparation steps were kept the same as those in Embodiment 1. In comparison with Embodiment 1, due to too small an addition amount of stearic acid, when modified calcium oxide prepared by this solution was used for printing, there still existed an obvious agglomeration phenomenon due to little stearic acid covering a surface of the calcium oxide powder, and thus a ceramic shell/core primary blank could not be effectively printed.

### Comparative Example 3

“5 g stearic acid and 95 g anhydrous ethanol were mixed” in the step (1) of Embodiment 1 was replaced with that “11 g stearic acid and 89 g anhydrous ethanol were mixed”. Remaining preparation steps were kept the same as those in Embodiment 1. In comparison with Embodiment 1, since the content of stearic acid was high enough and a specific surface area of the calcium oxide powder was constant, an increase in the content of stearic acid had a small influence on a contact angle of the modified calcium oxide powder, a final printed effect differed little from that of a sample in Embodiment 1, and a final printed ceramic core had slightly lower porosity.

### Test Embodiment

### Porosity Test

For molded samples prepared in Embodiments 1, 6, and 7 and Comparative Examples 1-3, primary blanks were prepared for different contents of modifiers as well as for corresponding adjusted modifying solvents (4 groups of parallel test blank samples were prepared for samples with the same content of stearic acid), porosity tests were performed on prepared finished soluble ceramic shells/cores, and obtained data were as follows in Table 1.

TABLE 1
Porosity of samples with different contents of stearic acid.

| | Content/% | Porosity | Porosity | Porosity | Porosity |
|---|---|---|---|---|---|
| | of stearic | % of | % of | % of | % of |
| No. | acid | Sample 1 | Sample 2 | Sample 3 | Sample 4 |
| Embodiment | 5 | 35.8 | 35.72 | 36.41 | 36.72 |
| 1 | | | | | |
| Embodiment | 1 | 38.14 | 39.26 | 38.45 | 38.6 |
| 6 | | | | | |
| Embodiment | 10 | 29.56 | 28.78 | 28.61 | 29.93 |
| 7 | | | | | |
| Comparative | — | — | — | — | — |
| Example 1 | | | | | |
| Comparative | 0.8 | — | — | — | — |
| Example 2 | | | | | |
| Comparative | 11 | 28.18 | 28.32 | 28.38 | 29.12 |
| Example 3 | | | | | |

As shown in Table 1, four groups of parallel experiments were performed on molded samples with different contents, modifiers in Embodiments 1, 6, and 7 were stearic acid, porosity of the samples in Embodiments 1, 6, and 7 and in Comparative Examples 1, 2, and 3 was compared, and the porosity of one prepared sample could meet requirements when the amount of the modifier was 1-10 parts by mass.

Comparing the porosity of the samples in Comparative Example 2 and Embodiment 1, due to the low amount of stearic acid in Comparative Example 2, when prepared modified calcium oxide was used for printing, there still existed an obvious agglomeration phenomenon due to little stearic acid covering a surface of the calcium oxide powder, thus a ceramic shell/core primary blank could not be effectively printed, and the porosity could not be measured.

Comparing the porosity of the samples in Comparative Example 3 and Embodiment 1, since the content of stearic acid was high enough and a specific surface area of the calcium oxide powder was constant, an increase in the content of stearic acid had a small influence on a contact angle of the modified calcium oxide powder, a final printed effect differed little from that of the sample in Embodiment 1, and a final printed ceramic core had slightly lower porosity.

The above describes the preferred embodiments of the present invention and is not intended to limit the present invention. Any modification, equivalent replacement, and improvement made within the spirit and scope of the present invention shall fall within the protection scope of the present invention.

What is claimed is:

1. A preparation method of a soluble ceramic shell/core, comprising the following steps:
step S1: performing ball milling and drying on a raw material containing calcium oxide and a modifying solution, and performing sieving to obtain a modified calcium oxide powder;
step S2: printing the modified calcium oxide powder into a ceramic shell/core primary blank, and performing heat curing, infiltration and drying to obtain a ceramic shell/core blank; and
step S3: sintering the ceramic shell/core blank to obtain the soluble ceramic shell/core; wherein
in the step S1, the modifying solution comprises a modifier and a modifying solvent;
the modifier is selected from at least one of ethyl bromide, bromobenzene, a silane coupling agent, stearic acid, or n-octadecyltrichlorosilane;
the modifying solvent is selected from at least one of methanol, ethanol, glycerol, or acetone;
by mass, the amount of the modifier is 1-10 parts, and the amount of the modifying solvent is 99-90 parts;
in the step S1, by mass, the amount of the calcium oxide is 30-70 parts, and the amount of the modifying solution is 70-30 parts;
in the step S1, time of the ball milling is 6 h-12 h;
in the ball milling, a diameter of a milling ball is 0.8 mm-2 mm;
in the ball milling, a mass fraction of the milling ball is 5%-15% that of the raw material;
a temperature of the drying is 50° C.-100° C., and time of the drying is 6 h-24 h; and
in the sieving after the drying, a mesh count of a sieve is 100 mesh-500 mesh.

2. The preparation method according to claim 1, wherein in the step S2, a temperature of the heat curing is 150° C.-180° C., and time of the heat curing is 2 h-5 h;
a temperature of the drying is 50° C.-90° C., and time of the drying is 8 h-24 h;
time of the infiltration is 30 s-3 min; and
in the step S2, an infiltration liquid used in the infiltration is selected from at least one of a nano-SiO₂ ethanol dispersion, a nano-ZrO₂ ethanol dispersion, or a nano-YiO₂ ethanol dispersion.

3. The preparation method according to claim 1, wherein in the step S2, a layer height of the printing is 0.05 mm-0.20 mm; and
an adhesive for the printing is phenolic resin, and saturation of the adhesive is 70%-140%.

4. The preparation method according to claim 1, wherein in the step S3, the sintering comprises first sintering and second sintering;
a temperature of the first sintering is 600° C.-800° C., and time of the first sintering is 1 h-3 h;
a temperature of the second sintering is 1300° C.-1500° C., and time of the second sintering is 2 h-3 h; and
a heating rate of the sintering is 1° C./min−5° C./min.

5. A soluble ceramic shell/core prepared and obtained by the preparation method according to any one of claims 1-4.

6. An application of the soluble ceramic shell/core according to claim 5 in a cast structural member, wherein a material of the cast structural member is selected from at least one of cast iron, cast steel, an aluminum alloy, a titanium alloy, or a magnesium alloy.
